(19) United States
(12) Patent Application Publication
(10) Pub. No.: US 2008/0097633 A1
(43) Pub. Date: Apr. 24, 2008

(54) BEAT MATCHING SYSTEMS

(75) Inventors: Daniel Scott Jochelson, Richardson, TX (US); Allison Frantz Mayrgundter, Houston, TX (US); Charles Eric McCallum, Dallas, TX (US); James Lawrence Randall, Richardson, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/864,128

(22) Filed: Sep. 28, 2007

Related U.S. Application Data
(60) Provisional application No. 60/827,500, filed on Sep. 29, 2006.

(51) Int. Cl. G06F 17/00

(52) U.S. Cl. 700/94

(57) ABSTRACT

Beat detection in audio streams for various applications: (i) to encourage desired athletic parameters, such as target or current heart rate, during training or workout by adjusting tempo of accompanying music; (ii) to monitor operating conditions of mechanical devices which inherently include vibrations; (iii) to synchronize audio play-out beat rate to mechanical device beat rate.

### CROSS-REFERENCE TO RELATED APPLICATIONS

This application claims priority from U.S. provisional patent Appl. No. 60/827,500, filed Sep. 29, 2006. Copending, co-assigned application Ser. Nos. 11/371,597, filed Mar. 9, 2006, and 11/469,745, filed Sep. 1, 2006, disclose related subject matter.

### BACKGROUND OF THE INVENTION

The invention relates to electronic devices, and, more particularly, to circuitry and methods for beat detection in audio streams and applications.

In recent years, methods have been developed which can track the tempo of an audio signal and identify its (musical) beats. This has enabled various beat-matching applications, including beat-matched audio editing, automatic play-list generation, and beat-matched crossfades. Indeed, in a beat-matched crossfade, a deejay slows down or speeds up one of the two audio tracks so that the beats between the incoming track and the outgoing track line up.

With the popularity of portable audio devices in athletic pursuits, today's exercise enthusiasts choose their individual music to motivate their workouts. They will select songs to motivate them to run/cycle at a desired target rate (e.g., running at a pace of eight minutes per mile where their steps match the musical downbeat), but the original music beat rate may not match their exact desired rate for the workout. Also, variations in the beat rate between songs can speed up or slow down the athlete. This lack of control over the exact music beat rate can cause the athlete to run/cycle/exercise faster or slower than the desired target.

Approaches to include bio-metric data to influence audio playback can be found in US patent publications 2005/0126370 and 2006/0112808 and in Japanese Kokai 2002-073018.

Maintenance/monitoring of machinery often involve heat and pressure sensors, which usually signal a problem only after a catastrophic failure. Some equipment and/or machinery is remotely located (e.g. cellular sites, radio repeater sites, pipeline “lift” stations), where it is far less costly to provide scheduled and preventive maintenance in good weather than to provide system critical repairs in poor weather, when it is difficult or impossible to travel to the site. Various machinery emits consistent, repetitive beat sounds; for example: fans in environmental air handler (for temperature, humidity, filtration, etc.); pumping stations (water, petroleum, sewer, etc.); rotating machinery, piston movement, horizontal repetitive motion, vertical repetitive motion (e.g., bottling machine, stamper), conveyor belt, bucket lift. If these repetitive sounds change drastically in their beat rate, it can signify a problem with the machinery that may need to be fixed. If additional, extraneous sounds occur within a consistent beat signal, this can also signify a problem.

People who interface with machines (i.e. assembly line workers in factories) are often asked to work at the same pace as the machines. These factories are often looking for methods to motivate their employees to work at the machine's pace. Music can be a motivating force for these employees. Simply playing music over a loudspeaker would not synchronize the workers to the machine's pace.

Beat detection for a digital audio stream can be performed in various ways. A simple approach just computes autocorrelations and selects the beat period as the delay corresponding to the peak autocorrelation. Alonso et al., “Tempo and Beat Estimation of Musical Signals”, Proc. Intl. Conf. Music Information Retrieval (ISMIR 2004), Barcelona, Spain, October 2004, proceeds through three steps: First an onset detector analyzes the audio signal and produces scalars that reflect the level of spectral change over time; this uses short-time Fourier transforms and differences the frequency channel magnitudes. The differences are summed and a threshold is applied through a median filter to output a detection function that shows only peaks at points in time that have large amounts of spectral change. Second, the detection function is fed to a periodicity estimator which applies spectral product methods to evaluate tempo (beat rate) hypotheses; this gives the beat rate estimate. In the third step a beat locator uses the detection function and the estimated beat rate to determine the locations of the beats in a frame.

All beat matchers must mitigate the limitations of the beat detection method which they employ. This includes the tendency of beat detectors to jump from one tempo beats-per-minute value to a harmonic or sub-harmonic thereof between analysis frames.

Another important characteristic for beat matchers is to avoid excessively modifying the input music being matched to another (reference) music or beat source track. Typically, modifications are either time-scale modifications (TSM) or sampling rate conversions (SRC). FIG. 2a generally shows a beat matching (input beats bi[k] modified to align with reference beats br[k]), and FIG. 2b illustrates TSM versus SRC. For shrinking/expanding a time scale, TSM essentially deletes/replicates some information to preserve local structure, whereas SRC uniformly shrinks/expands everything.

TSM methods change the time scale of an audio signal without changing its perceptual characteristics. For example, synchronized overlap-and-add (SOLA) provides a time scale change by a factor r by taking successive length-N frames of input samples with frame k starting at time kT_{analysis} and aligning frame k to (within a range about) its target synthesis starting time kT_{synthesis} (where T_{syntesis}=rT_{analysis}) in the currently synthesized output by optimizing the cross-correlation of the overlap portions and then adding aligned frame k to extend the currently synthesized output with averaging of the overlap portions. Various SOLA modifications lower the complexity of the computations; for example, Wong and Au, Fast SOLA-Based Time Scale Modification Using Modified Envelope Matching, IEEE ICASSP vol. III, pp. 3188-3191 (2002).

Sampling rate conversion (which may be asynchronous) theoretically is just analog reconstruction and resampling, i.e., non-linear interpolations. Ramstad, Digital Methods for Conversion between Arbitrary Sampling Frequencies, 32. IEEE Tr. ASSP 577 (1984) presents a general theory of filtering methods for interfacing time-discrete systems with different sampling rates and includes the use of Taylor series coefficients for improved interpolation accuracy.

### SUMMARY OF THE INVENTION

The present invention provides beat detection for audio play as athletic/user incentive, monitoring mechanical devices, and/or synchronization of audio play to mechanical devices.

### BRIEF DESCRIPTION OF THE DRAWINGS

FIGS. 1a-1c are functional block diagrams and flowchart of a preferred embodiment beat matching on a portable audio device during workout.

FIGS. 2a-2c show beat-matching waveforms and time-scale modification versus sampling rate conversion plus a combination.

FIGS. 3-6 illustrate further preferred embodiment beat matchings for portable audio devices.

FIGS. 7-9 illustrate preferred embodiment beat matchings for exercise equipment.

FIGS. 10-11 are preferred embodiment flowcharts.

FIGS. 12-13 show preferred embodiment mechanical device monitoring.

FIGS. 14-15 illustrate preferred embodiment music synchronization to mechanical devices.

### DESCRIPTION OF THE PREFERRED EMBODIMENTS

1. Overview

Preferred embodiments provide architectures and methods for applications of beat detection including athletic/exercise workout incentive, monitoring mechanical devices, and/or beat matching of audio playout to the mechanical device as beat source.

Preferred embodiment systems implement preferred embodiment architectures and methods with any of several types of hardware: digital signal processors (DSPs), general purpose programmable processors, application specific circuits, or systems on a chip (SoC) such as combinations of a DSP and a RISC processor together with various specialized programmable accelerators such as for FFTs and variable length coding (VLC). For example, the 55x family of DSPs from Texas Instruments has sufficient power. A stored program in an onboard or external (flash EEP)ROM or FRAM could implement the signal processing. Analog-to-digital converters and digital-to-analog converters can provide coupling to the real world, modulators and demodulators (plus antennas for air interfaces) can provide coupling for transmission waveforms, and packetizers can provide formats for transmission over networks such as the Internet.

2. Portable Audio with Selected Tempo

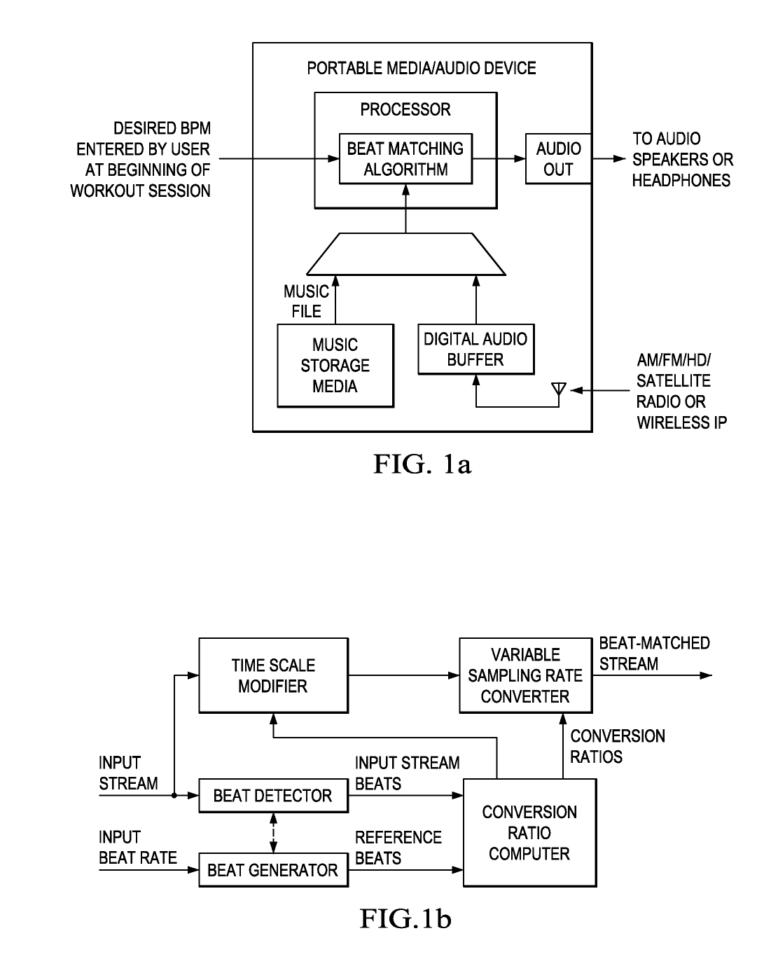

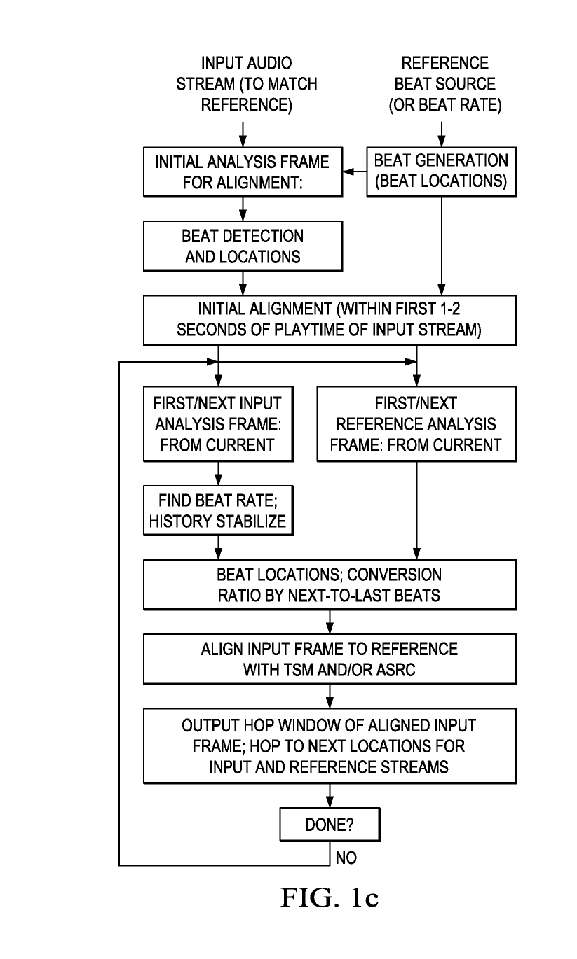

FIG. 1a illustrates functional blocks of a first preferred embodiment portable audio/media device which can be used for athletic training. An athlete (user) carries the portable device during training to play music to accompany a workout which has a selected target level of effort (e.g., target heart rate); a digital processor in the portable device beat matches the music to play at a beat rate compatible with the target effort level. In particular, prior to the workout, the user (athlete) enters a tempo (beats per minute) plus selects a source for music to play during the workout, such as songs stored on the portable device and/or wireless streaming downloads to the portable device. Then during the workout, the portable device alters the playback speed (beat matches) of the music being played in real-time to match the entered tempo. The portable device sends out the altered audio to be played by speakers or headphones. FIG. 1b illustrates the functional blocks of a beat matcher which can be implemented on a portable audio/media device, and FIG. 1c is a flowchart.

In effect, the same music can be played with different tempos during different workouts by selecting different beat rates. Thus, an athlete can listen to favorite music which is beat-adapted to a target workout effort level.

3. Portable with Metric to Tempo Conversion

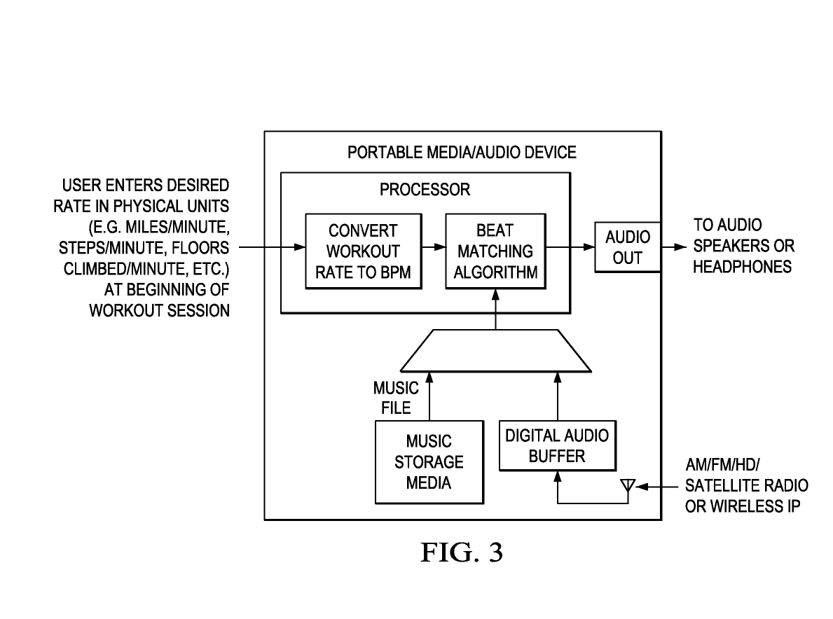

FIG. 3 illustrates functional blocks of a preferred embodiment portable audio device which extends that of FIG. 1a by providing automatic conversion of workout metrics (e.g., miles run per minute, number of stair-machine steps taken per minute, number of floors climbed per minute) into beats per minute for music playback. Thus, prior to the workout, the athlete enters a target workout metric plus selects a source for music to play during the workout. The portable audio device converts this entered workout metric into a tempo (beat rate). This conversion calculation could be statically defined, or if the device is able to store historical data from previous exercise sessions, the conversion calculation could be modified/tuned for this particular athlete. Then during the workout, the portable device alters the playback speed (beat matches) of the music being played to match the computed beat rate. The portable device sends out the altered audio to be played by speakers or headphones.

4. Portable with Selected Workout Profile

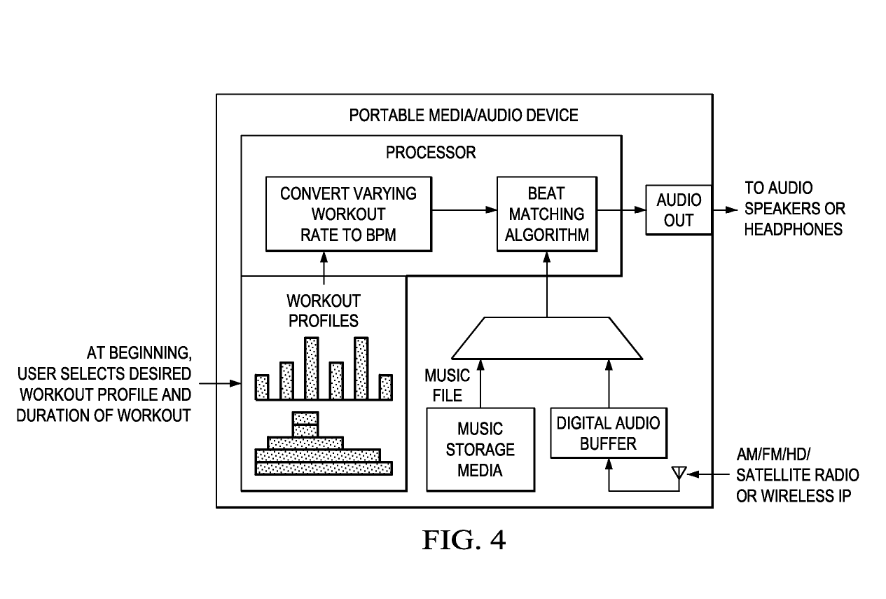

Many workout machines contain a set of “workout profiles” (e.g., hill climbing profile, fat burn profile, cardio profile, etc.) that increase/decrease speed or resistance throughout the workout. FIG. 4 illustrates functional blocks of a preferred embodiment portable audio device which contains some of these workout profiles as well as functionalities of the FIGS. 1a and 3 preferred embodiments. Prior to a workout, the athlete would select a workout profile. As the workout rates vary during the exercise session, the tempo (beat rate) for the music also varies in real-time to encourage the athlete to maintain the pre-selected workout profile targets.

5. Portable with Feedback Control

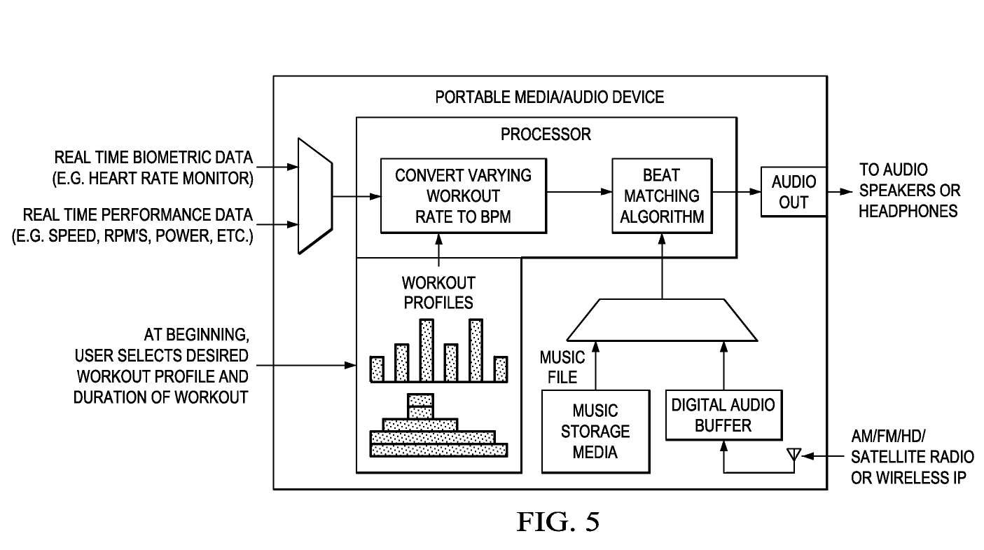

FIG. 5 illustrates functional blocks of a preferred embodiment portable audio/media device which extends functionalities of the FIGS. 1a, 3, and 4 portable devices by performance feedback control of the tempo. During a workout, biometric sensors (e.g., a heart rate monitor) are used to track the athlete's physical state. Also, real-time performance data may be recorded (e.g., a pedometer recording speed, a microphone recording number of steps, etc.). If the workout profile is for performance (e.g., speed, etc.), then the real-time performance data is analyzed by the portable device to determine whether performance targets are being met; if not, then the portable device increases the music speed (increase tempo) to encourage increased effort.

If the workout profile is for biometric targets (e.g., target range for heart rate), then the real-time biometric data is used to increase/decrease the music speed when the athlete is below/above the target range (see Section 10 for more details on motivational aspect of this invention). Biometric and/or performance data may be provided by individual sensors (either internal to or external to the portable device) or by an exercise machine.

In particular, prior to the workout, the athlete selects a beat source, such as a wired or wireless heart monitor, selects a performance and/or biometric target, and then selects a source for music to play during the workout. Then during the workout, the portable device analyzes sensor inputs to determine whether performance and/or biometric targets are being met and computes a beat rate. The beat matcher then adjusts the tempo (alters the speed) of the music being played to match the computed beat rate. The beat rate computation can be according to a simple algorithm. For example, let BPMᵢₙₚᵤₜ denote the input rate from a heart monitor, BPM_{target} denote the target heart rate for the workout (which can be programmed to vary in time), and BPM_{music} denote the music tempo, then BPM_{music} could be determined as:
BPM_{music}=BPMᵢₙₚᵤₜ+constant*(BPM_{target}−BPMᵢₙₚᵤₜ)
where the constant can be programmed and even adjusted over time. Thus with a positive constant (e.g., 0.5), when the athlete's heart rate is below target, the music tempo is computed to exceed the current heart rate by a fraction of the target miss, and similarly when the athlete's heart rate is above target, the music tempo is computed to be less than the current heart rate by a fraction of the target miss. More generally, the square of the target miss, or other non-linear function of the target miss could be used. Coincidentally, common aerobic workout heart rates are similar to many song tempos; e.g., 120-150 beats per minute; so the beat matcher typically will not distort the song beyond familiarity.
6. Portable with Profiles, Feedback Biometric Plus GPS

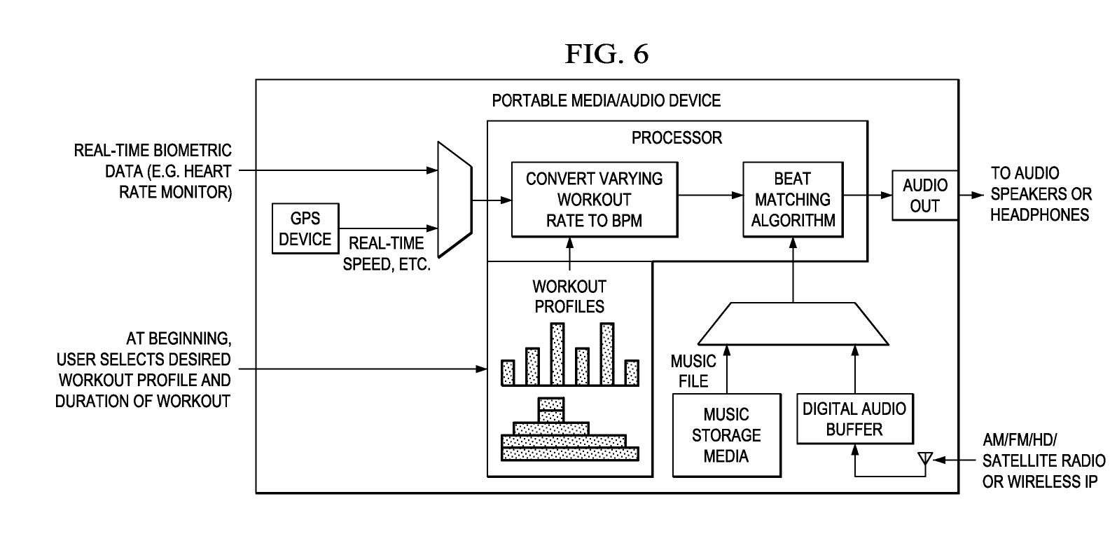

FIG. 6 illustrates functional blocks of a preferred embodiment portable audio/media device which extends that of FIG. 5 with the addition of a GPS receiver for further performance data generation. The GPS receiver (either built into the portable audio device or separate and plugged into the portable audio device) can provide performance data (e.g., miles run), and this can be converted into speed data which is analyzed and then used in the computation of the music beats per minute as in the portable device of FIG. 5.

7. Exercise Equipment

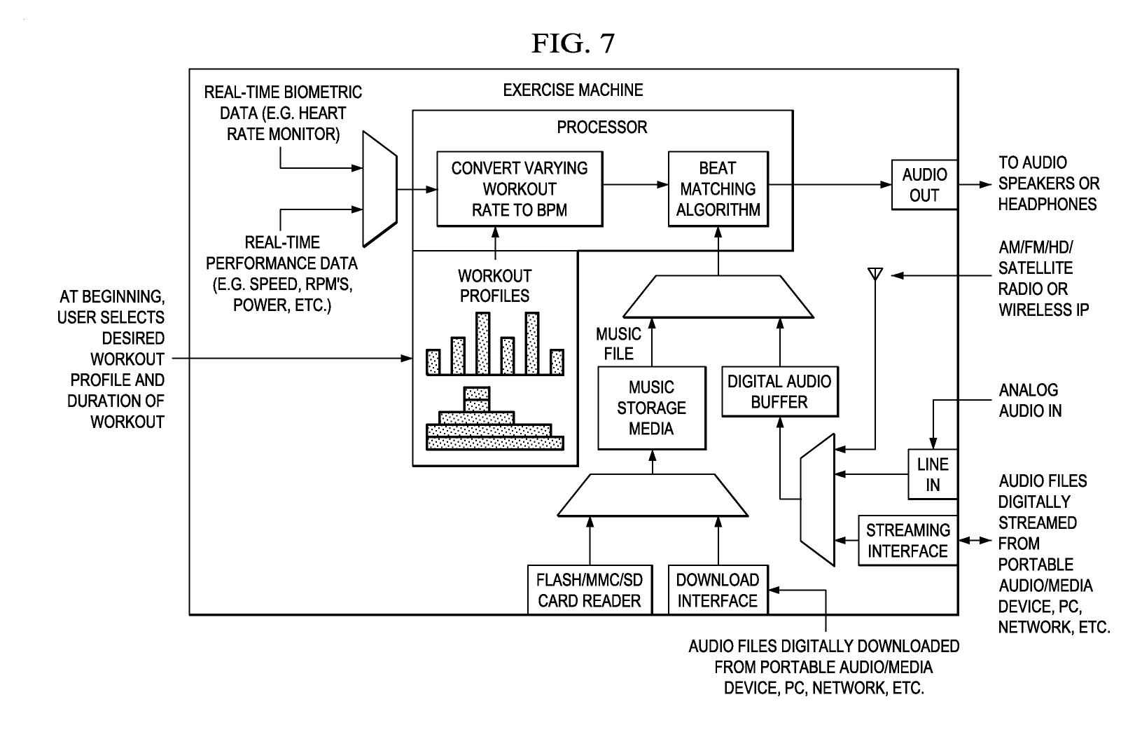

FIG. 7 illustrates an exercise equipment preferred embodiment with built-in beat matching and audio playout. Typical exercise equipment provides selection from a variety of workout profiles plus captures biometric and performance data to display it for the athlete. For example:
Treadmill (speed, incline, power/work, calories burned, heart rate, etc.)—
StairMaster (floors per minute, power/work, heart rate, etc.)—
Bicycle (RPMs, speed, heart rate, etc.)—
Elliptical machines (steps per minute, distance, heart rate, etc.)
   Some exercise machines already beep or flash when the desired workout rate is not being met. This beep/flash could be replaced with adjustment of the speed of the music accompanying the workout.

As illustrated in FIG. 7, a preferred embodiment exercise equipment takes advantage of this data and provides exercise equipment with built-in beat rate target calculator, a beat matcher, audio storage or streaming input, and audio player which use the selected workout profile plus captured biometric and/or performance data to compute beat rate conversions for music selected to accompany the workout. In particular, preferred embodiment exercise machines add a headphone jack, plus various media delivery methods, to allow the athlete to listen to music through the exercise machine. The possible music delivery methods include:
Media storage card reader (e.g., Flash card, MMC, SD card, etc.)—
Download interface (e.g., USB, WiFi, WLAN, Portable audio device, etc.)—
Broadcast streaming (e.g., AM/FM/HD/Satellite radio)—
Streaming interface with two-way communication (allows the exercise machine to communicate with the audio source about the audio being consumed, which is very useful if the source is performing audio decoding, so that input rate can be controlled).
   8. Exercise Equipment with Portable Device Source

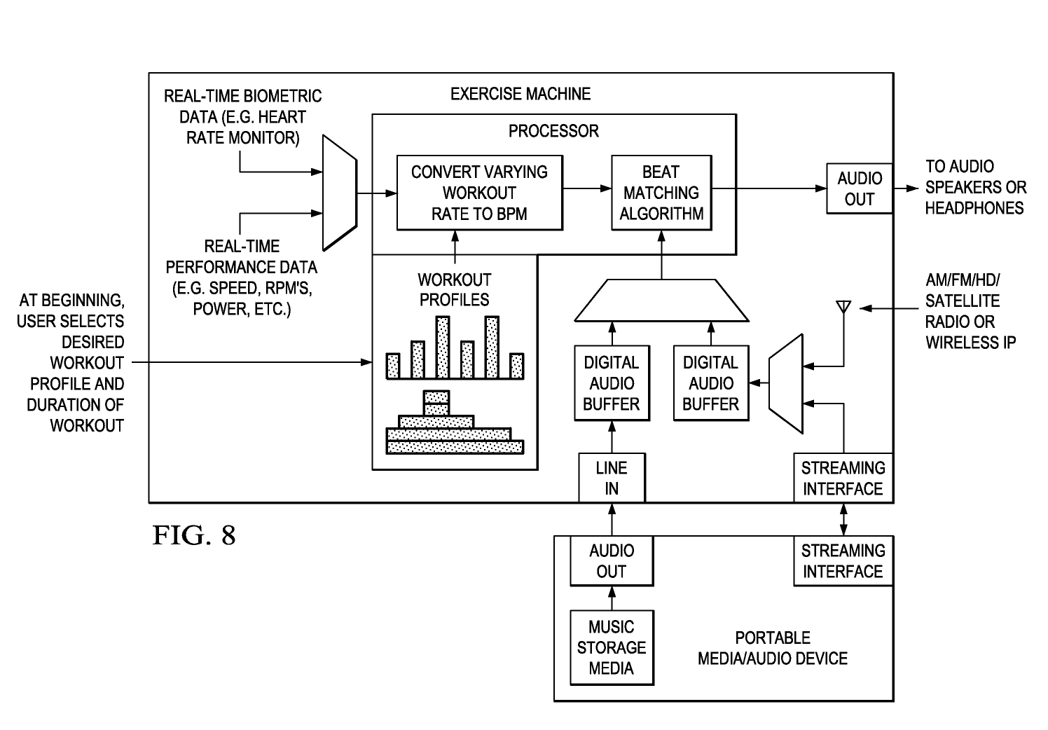

FIG. 8 illustrates an exercise equipment preferred embodiment which extends that of FIG. 7. In particular, an athlete could have all desired workout music already stored on a portable audio device and not want to download onto the exercise machine (or the exercise machine might lack download capabilities). Simply plugging a portable audio device into the exercise machine and streaming the audio through this machine would be a popular application.

The audio output of the portable audio device is streamed into the exercise machine (with a buffer for the incoming audio provided by the exercise machine). The streaming could be done either in the analog domain (i.e., audio-out/line-in) or be done digitally. An advantage of performing this digitally is that the exercise machine can monitor its (variable) consumption of the digital audio buffer data during the streaming, and then communicate via the two-way streaming interface with the portable audio device to request the appropriate amount of audio data to fill the buffer. As the audio is streamed through the exercise machine (with some delay due to the buffering), the athlete can listen to the speed-altered (beat-matched) output on the output jack of the exercise machine.

9. Exercise Equipment Influencing Portable Audio Player

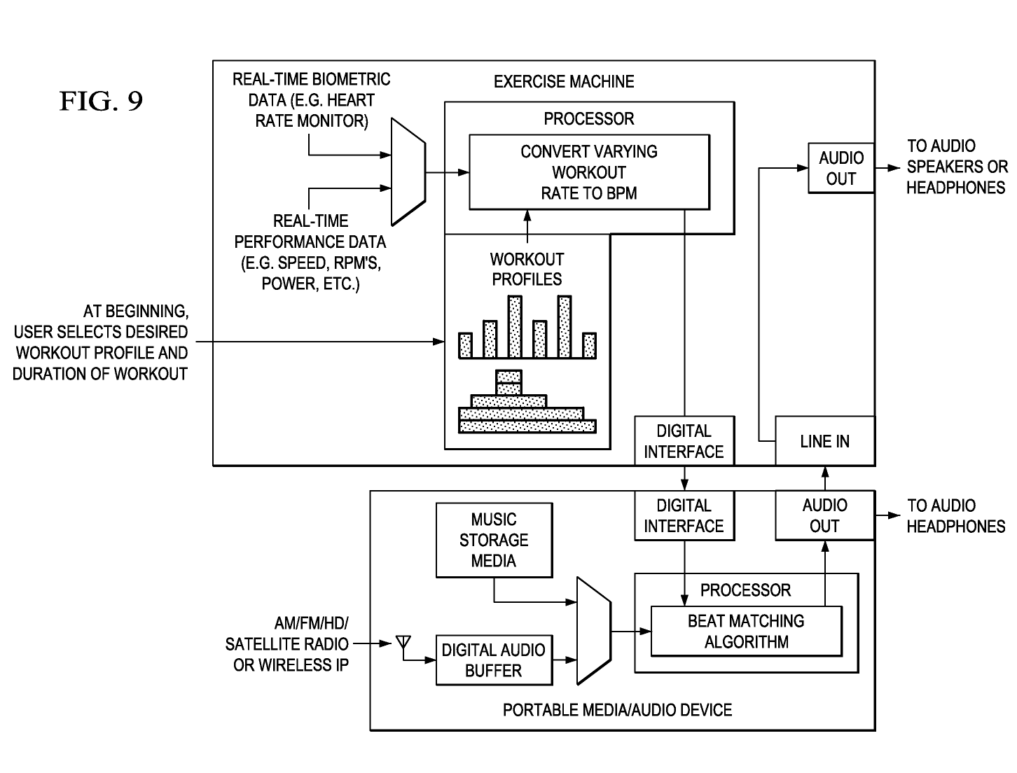

FIG. 9 illustrates a further preferred embodiment utilizing both an exercise machine and a portable audio device and extends the preferred embodiment of FIG. 8. Instead of placing both the bpm (beats per minute) target calculation and the beat matching method on the exercise equipment, the FIG. 9 preferred embodiment simply adds the bpm target calculation to a standard exercise machine and provides a digital interface to send this data to an external device, such as a portable audio player. Beat matching is performed on the portable audio device using the bpm target from the exercise machine. The speed-altered output from the beat matching method can be streamed to headphones connected to the audio out jack on the portable audio device. Alternatively, the speed-altered audio could be streamed into the exercise machine via a Line-In port, and this audio could then be sent to a speaker connected to the exercise machine. This output speaker connected to the exercise machine can be used in an athletic class (e.g., a cycling class) at a health club. For example, a teacher cycles at a particular rate, producing music that influences the class to cycle at that rate.

The FIG. 9 configuration allows beat matching to occur on the portable audio device, using data obtained from the exercise machine. Flexibility in the output jack used (either from the portable audio player or the exercise machine) allows the user to decide whether to carry a portable audio player or not. Use of the exercise machine output jack allows setting the portable audio player on the exercise machine's storage space.

10. Real-Time Beat Matching for Athletic Pursuits

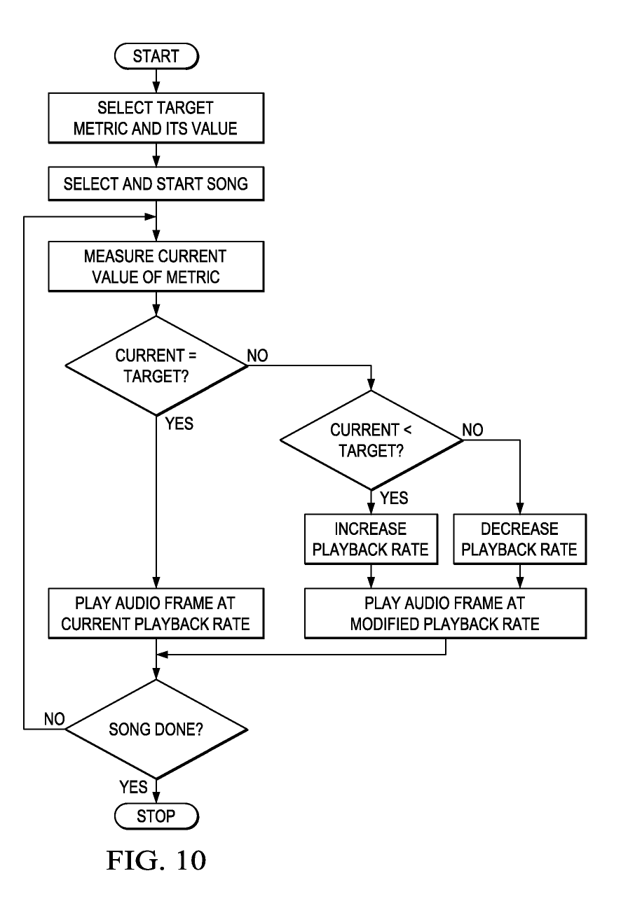

FIG. 10 illustrates a program flow for the case where the user aims to match a biometric or performance target for the duration of a single song. By periodically comparing the current value of the biometric or performance data with the target value of this data, the system can continually generate updated playback rates to motivate the user. At the beginning of the task or workout, the user selects a target value for a specific metric (e.g. heart rate, speed, etc.) they wish to track. After starting the song, the metric is periodically monitored for the current value. If the current value is sufficiently close to the target value, then no alteration is needed to the playback rate for the current audio frame. However, if the current value is below the target value, then the playback rate needs to be increased to motivate the user to raise the level of the biometric or performance data. Conversely, if the user is exerting himself too much, then the metric will be above the target value, and thus needs a lowered playback rate for the motivational music. This process is continued repeatly until the end of the song is reached.

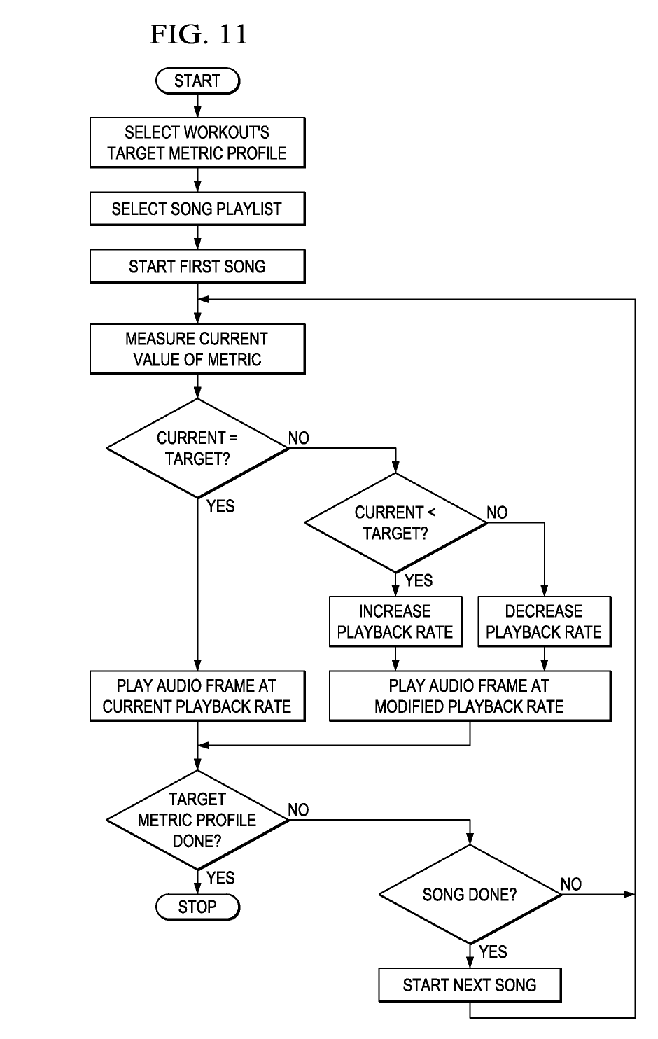

FIG. 11 illustrates an expansion of this system to handle workout profiles and song playlists. Instead of selecting a single target value, the user can choose how this target value will change over the time of the workout (hereafter referred to as the “target metric profile”). In addition, the user can select multiple songs (i.e. a playlist), and each of these songs will be adapted in real-time to new playback rates to motivate the user. Much of the functionality is similar to the previous case, but the termination of this workout is dependent on the end of the target metric profile, instead of the end of a single song. Thus, if the end of a song is reached before the end of the target metric profile, the next song in the playlist is started.

Note that this is not limited to a single target metric. The playback rate can be a function of multiple biometric/performance metrics, and with different weights assigned to each metric. For example, if both speed and heart rate are monitored, they could be combined during the comparisons with the target values. If H_{CURR} and H_{TARGET} represent the current heart rate and target heart rate, respectively, and S_{CURR} and S_{TARGET} designate the current and target speeds, then the following decision table could be formulated:
H_{CURR}<H_{TARGET}, S_{CURR}<S_{TARGET}: greatly increase playback rate, as both biometric and performance data are below target
H_{CURR}<H_{TARGET}, S_{CURR}>S_{TARGET}: slightly increase playback rate (if cardiovascular workout), or slighty decrease playback rate (if training for desired pace)
H_{CURR}<H_{TARGET}, S_{CURR}<S_{TARGET}: slightly decrease playback rate (if cardiovascular workout), or slightly increase playback rate (if training for desired pace)
H_{CURR}>H_{TARGET}, S_{CURR}>S_{TARGET}: greatly decrease playback rate, as both biometric and performance data are above target
   This use of beat matching to motivate the user to achieve certain biometric and/or performance metrics can greatly enhance the user experience, as they can achieve athletic goals with more precision while enjoying their current music playlists.
   11. Beat Matching Architecture

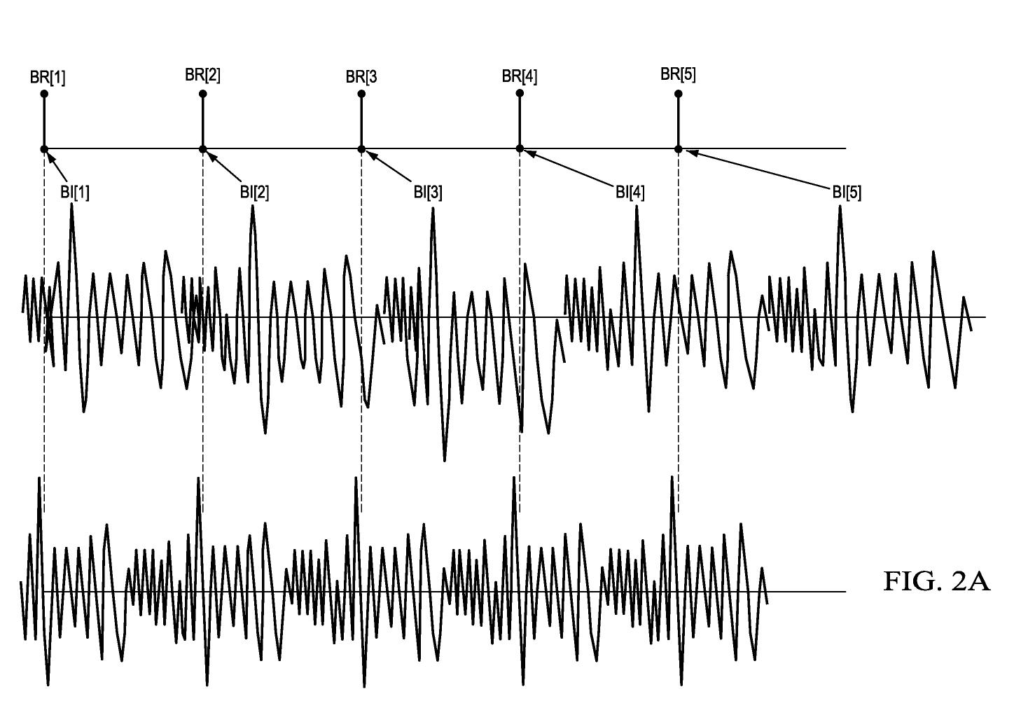

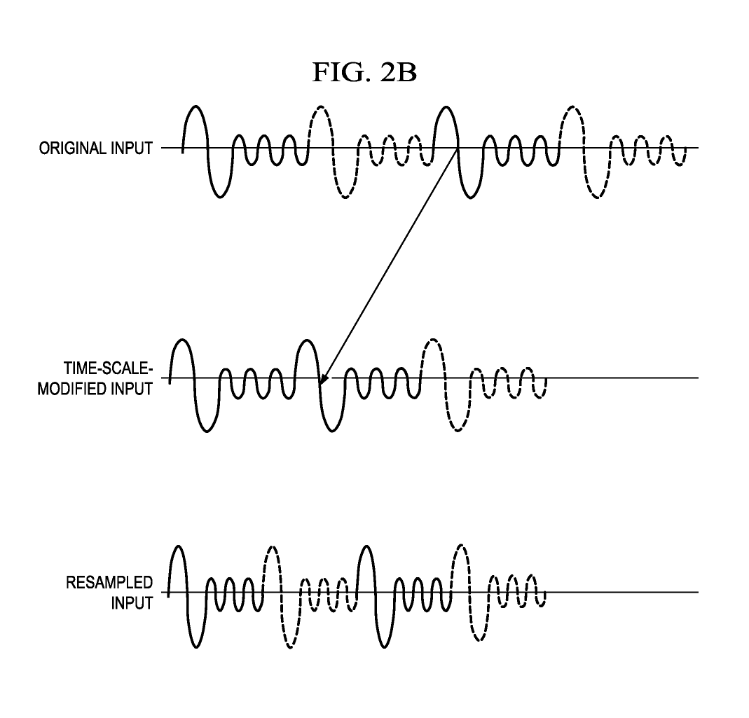

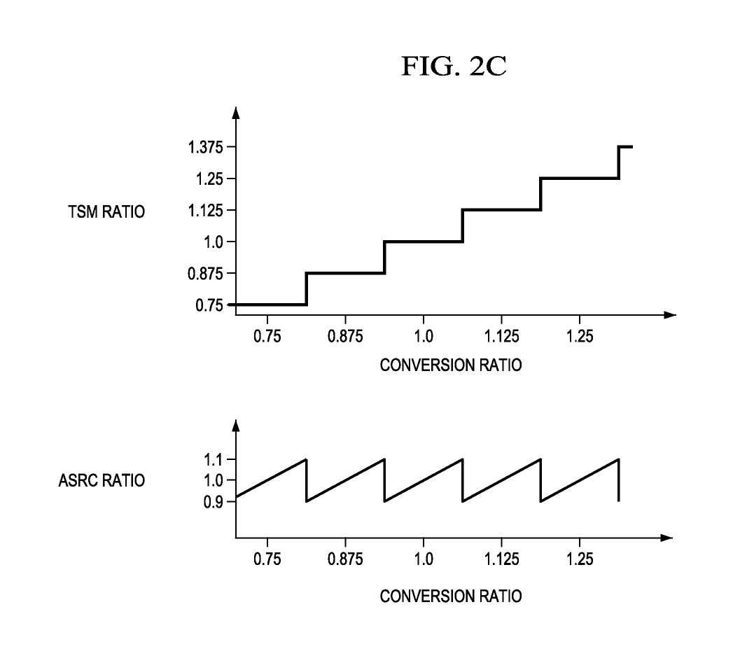

FIG. 1b illustrates functional blocks of a preferred embodiment beat matching architecture which includes beat detector, beat generator, a conversion ratio computer, and both a time-scale modifier and a variable sampling rate converter. The preferred embodiment methods start with an initial alignment of the input digital audio stream to the reference stream (beats generated from the beat source input) by alignment of a beat detected near the beginning of the input stream with a beat generated for the reference, and then continue with beat-matching on a frame-by-frame basis using both the TSM and the VSRC (variable sampling rate converter) to modify the input stream to beat match the reference stream. The frames are 10-second intervals of stream samples, and adjacent frames have about a 50% overlap. Note that a 10-second interval corresponds to 441,000 samples when a stream has a 44.1 kHz sampling rate. Also, a tempo of 120 beats per minute (bpm) would yield about 20 beat locations detected in a frame. The frame size could be larger or smaller; the 10-second frame was selected as a compromise between accuracy and memory requirements. For the reference stream from a beat source such as a heart rate monitor, a pedometer, or even a software beat generator, a beat location generator would provide the beat locations; see FIG. 1b. And the computed overall conversion ratio (R[n]) necessary to align the input stream beats in the nth frame to the reference stream beats is factored into a product of a TSM conversion ratio and a VSRC conversion ratio as illustrated in FIG. 2c. In particular, TSM and VSRC conversion ratios (R_{TSM}[n] and R_{VSRC}[n]) are computed as:
R_{TSM}[n]=└R[n]/8+1/16┘
R_{VSRC}[n]=R[n]/R_{TSM}[n]
when |R[n]/R_{TSM}[n]−R_{VSRC}[n−1]|<|R[n]/R_{TSM}[n−1]−R_{VSRC}[n−1] |, but otherwise as
R_{TSM}[n]=R_{TSM}[n−1]
RVSRC[n]=R[n]/R_{TSM}[n]
The division by 8 in defining R_{TSM}[n] just reflects the step size of the TSM; with a different step size, the divisor and round-off would adjust.

As previously mentioned, the TSM provides coarse time-scale modification (in ⅛ increments between 4/8 and 16/8) and the VSRC provides variable time-scale adjustments. In these formulas, two TSM+VSRC, conversion ratios are computed, and the VSRC ratio closest to the previous value is selected (in order to avoid significant jumps in pitch). The first TSM ratio is obtained by rounding the overall conversion ratio to the nearest ⅛^{th} increment, and the first VSRC ratio is obtained simply by dividing the overall conversion ratio by the first TSM ratio (since the TSM+VSRC are connected in series). The second VSRC ratio is obtained by dividing the overall conversion ratio by the previous TSM ratio. As shown in FIG. 2c, using this scheme, the VSRC ratio varies between 0.90 and 1.10, which is slightly more than one semitone of pitch distortion.

12. Conversion Ratio Stability

The tempo reported by beat detectors has a tendency to jump between analysis frames. These tempo jumps can be harmonics or simple ratios of the previously-detected tempos in prior analysis frames. That is, the current tempo may be a multiple such as 2×, 0.5×, 3×, 0.67×, 1.5×, 1.33×, etc. of a prior tempo. These jumps are highly disruptive to the beat matcher, as they cause large, audible jumps in the conversion ratios from frame to frame.

Likewise, heart monitors and other parameter transducers may provide erratic inputs due to poor physical contacts, wireless interference, etc.; and even the physical beat source may have erratic output, such as heart beat transients or arrhythmia.

To remedy the tempo jump problem, the preferred embodiments maintain a history of prior tempo values for the input stream and the beat source (e.g., Bi and Br for prior frames) and adjust a current tempo from the previous tempos in the history, such as by a majority voting decision.

13. Monitoring Mechanical Devices

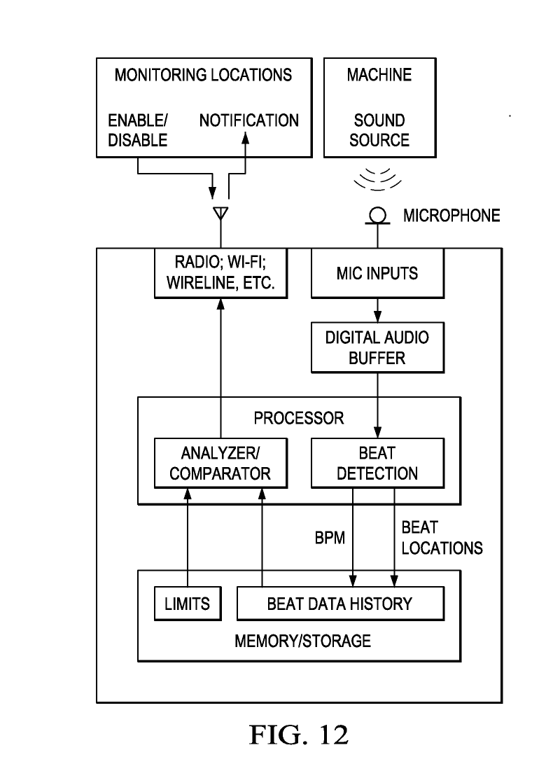

FIG. 12 illustrates a preferred embodiment monitoring system for mechanical devices, such as machinery used in factory production. A typical machine emits a regular, beat-like sound that is captured by an inexpensive microphone. This audio data is digitized (e.g., sampling rate of 8 kHz) and buffered in a 10-second audio buffer, and each subsequent observation frame has a 50% (e.g. 5 seconds of audio) overlap with the previous frame. For applications with high base pitch, such as 3000 Hz from a jet turbine, etc., a higher sampling rate would be used, together with a correspondingly shorter observation frame of samples for the audio buffer. Buffered audio data is fed to the beat detection method, which determines the Beats Per Minute (BPM), number of beats in the frame, and the beat locations within the frame. This information is saved into Beat Data History, which could reside on the processor or in external memory (e.g. SDRAM, etc.).

After each beat detection analysis frame, the Analyzer/Comparator will compare the current frame's data to the data in the Beat Data History. If the current frame has a significant variation from the history, or is approaching or exceeding the set limits, then the Monitoring Location(s) can be notified of this problem. This notification can occur through various transmission methods, both wired (landline, IP, etc.) and wireless (radio, WiFi, etc.). Analysis can be enabled/disabled from the Monitoring Location(s), if continuous analysis is not desired. Also, the Monitoring Location can enable the Audio Monitoring Device to send positive indications of correct operation. If Monitoring Location can also communicate with the Machine, it could shut off the Machine if the audio sensor records a problem. If remote communication with the Machine is not possible, a repair crew can be sent before the Machine's problem is critical (e.g. overheating, etc.).
Some types of machinery or systems that could benefit from employment of audio monitoring include:
   Environmental air handler fan
      Cellular sites
      Trunked radio sites
      Radio repeater sites
      Clean room in manufacturing or assembly facility
      Hospital operating room
   Pumping station machinery
      Water
      Petroleum
      Sewer
      Gas
   Electric Power Generator
   Wind Turbine
   Fluid flow detection/monitoring
   Rotating machinery
   Piston movement
   Horizontal repetitive motion, vertical repetitive motion (e.g. bottling machine, stamper)
   Conveyor belt
   Bucket lift
   Automotive sensors
   Traffic flow sensors

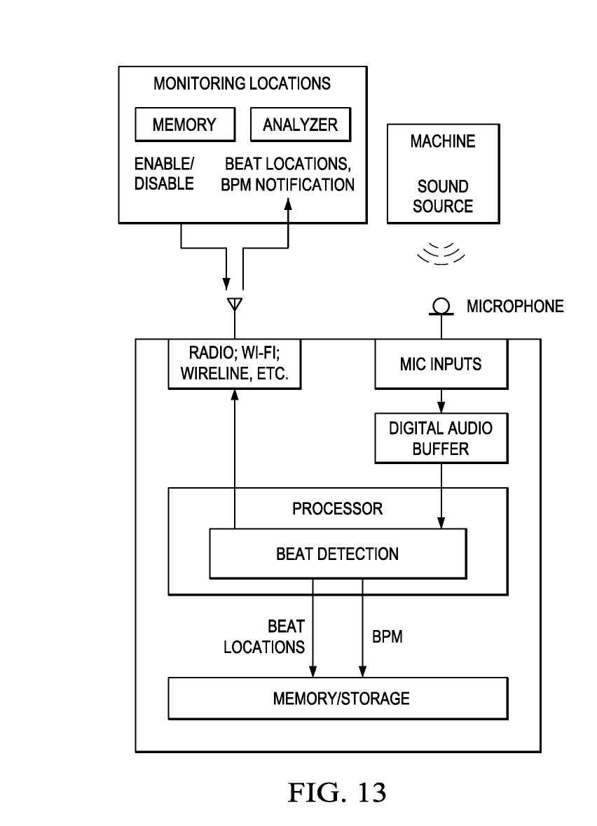

As illustrated in the preferred embodiment system of FIG. 13, when the Monitoring Location(s) desires more information than simple notification, the beat data (BPM, Beat locations, and number of beats) could be sent to this Location over a data channel with adequate bandwidth. The Monitoring Location(s) can use this more-detailed data to identify irregular beat locations/noises or detect subtle changes over longer periods of time. Storage of the beat data could occur at the Monitoring Location(s), on the Audio Monitoring Device, or in both places. Microphone recording, buffering, and beat detection analysis occurs in same manner as the previously described Embodiment.

In short, the preferred embodiments facilitate another diagnostic monitor for regular mechanical systems. No modification is required to the machine, motor, or apparatus being sensed. No machine (or production) downtime is required for installation. Little technical skill is required to install each sensing device. A single device can sense “within limits”, “out of limits”, and “approaching limits” operation of a system, as opposed to a component. (Most sensors can sense only a component of the system.) This diagnostic monitor provides alerts in order to perform preventive maintenance before system-critical problem occurs. This is a significant advantage over temperature and pressure sensors, which signal catastrophic problems like overheating and dangerous pressure levels. For remote locations, early-problem detection enables preventive maintenance that can be scheduled more easily (i.e. avoiding bad weather) than the fixing of catastrophic emergencies, which must be fixed immediately.

More particularly, the Analyzer/Comparator could have various status outputs such as “within normal limits operation”, “within safe limits operation high” (i.e., not normal, but not failed—indicating a future failure at the high limit), “within safe limits operation low” (i.e., not normal, but not failed—indicating a future failure at the low limit), “out of limits—high”, “out of limits—low”. Also multiple sets of parameters may be auto-sensed and/or adjusted to accommodate multiple sets of boundaries/multiple rates of operation (e.g., a fan that runs at high speed when heat rises, then slows when the temperature drops). The preferred embodiments have the ability to adapt and the ability to output multiple levels of performance/operation information.

14. Matching Music to Machinery and Other Beat Sources

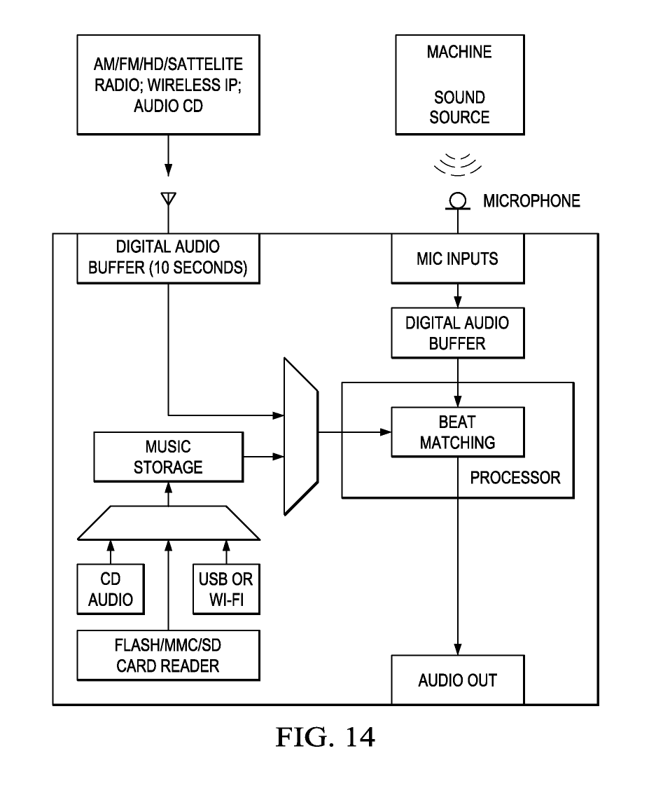

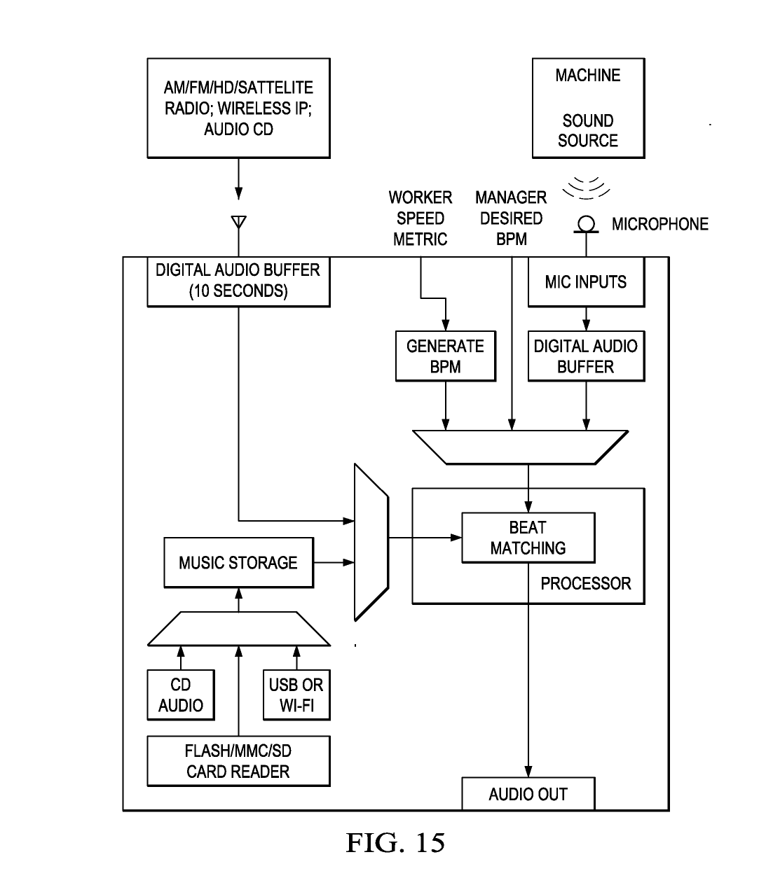

FIG. 14 shows a preferred embodiment system for synchronizing music played over loudspeakers (e.g. in a factory for assembly line workers) to the regular beats in the machine noise. This provides motivation for the workers (consciously or subconsciously) as they attempt to align their work with the machine. Machine beats are detected by a microphone, and the buffered audio data from this source is considered the reference stream (i.e. the stream whose beats we wish to match). Various input audio sources could be used: audio downloaded via Flash/MMC/SD cards, USB, WiFi, or CD audio; audio streamed from radio, WiFi, or CD audio (internal buffering provided by Audio Synchronizer).

Some types of “machines” that may require synchronization with people:
Packaging
Assembly
Conveyor belt
Stamper
   Medical Use for Passive Control of Elevated Breathing and/or Heart Rate and/or Blood Pressure:
Pulse or breathing rate may be detected with audio sensing
Beat matching may be used to provide Coordinated Feedback by matching the rate to music and interactively reducing the beat rate of the music
Coordinated Feedback can cause the heart rate and/or breathing rate and/or blood pressure to be reduced naturally

While the machine beat pattern could be used as the reference signal, other information could be used instead to control the playback rate of the music over the loudspeakers as illustrated in FIG. 15:

Workers' Speed Metric—
If worker is working too slowly, based on some metric, a higher Beats-Per-Minute (BPM) rate can be calculated. If worker defect rate is too high, a lower BPM rate can be calculated. The Beat Matching algorithm takes in this BPM rate and matches the input music to this rate.

Manager's Desired BPM—
The manager can override the automatic system by manually inputting a desired speed metric or the desired BPM rate.
The manager can also change the speed of the machine to match his new desired speed metric or BPM rate.
   This Audio Synchronizer for Assembly Lines/Interactive Rate Control motivates workers to keep pace with a machine or assembly line, and facilitates synchronization of workers to an assembly line. This allows the ability to tie music playback speed to workers' performance, creating a feedback system (music affecting the workers while the workers are influencing the music) converging toward a desired rate.

What is claimed is:

1. A music playout method, comprising the steps of:
(a) detecting information from a user, said information selected from the group consisting of biometric information, performance information, and combinations thereof;
(b) computing a difference between said information and a target;
(c) adjusting the tempo of music being played out for said user, said adjusting in response to the results of said computing a difference; and
(d) repeating steps (a)-(c).

2. The method of claim 1, wherein said information is acquired by at least one sensor directly connected to a portable audio device, said portable audio device for said music being played out, where said connection is a wired or wireless interface, and where said sensor is selected from the group consisting of (i) speed sensors, (ii) power/work sensors, (iii) heart rate sensors, (iv) perspiration sensors, (v) global positioning sensors; and (vi) combinations from (i)-(v).

3. The method of claim 1, wherein said information is acquired by at least one sensor directly connected to an exercise machine, where said connection is a wired or wireless interface, and where said sensor is selected from the group consisting of (i) speed sensors, (ii) power/work sensors, (iii) heart rate sensors, (iv) perspiration sensors, (v) global positioning sensors; and (vi) combinations from (i)-(v).

4. The method of claim 1, wherein said information is acquired by at least one sensor indirectly connected to a portable audio device through an exercise machine, said portable audio device for said music being played out, and where said sensor is selected from the group consisting of (i) speed sensors, (ii) power/work sensors, (iii) heart rate sensors, (iv) perspiration sensors, (v) global positioning sensors; and (vi) combinations from (i)-(v);

5. The method of claim 1, wherein said music is stored in an audio device, said audio device for said music being played out.

6. The method of claim 1, wherein said music is streamed to an audio device, said audio device for said music being played out.

7. A playout system, comprising:
(a) an input for real-time information from a user, said information selected from the group consisting of biometric information, performance information, and combinations thereof;
(b) a source for an audio signal;
(c) an audio player, said audio player coupled to said source and to said input, wherein said audio player controls the tempo of an audio signal from said source for playout for said user, where said control is in response to a difference between said real-time information and a target.

8. The system of claim 7, wherein said source is a memory connected to said audio player.

9. The system of claim 7, wherein said source is an input forstreaming audio.

10. A method of mechanical device monitoring, comprising the steps of:
(a) extracting beat data in an audio signal generated by at least one mechanical device during a first time interval;
(b) analyzing said beat data using prior beat data extracted from audio signal generated by said at least one mechanical device during prior time interval; and
(c) providing a status output from said analyzing.

11. The method of claim 10, further comprising a step of enabling/disabling said extracting beat data, said enabling/disabling by a signal from a recipient for said status output.

12. The method of claim 10, wherein said status output is selected from the group consisting of normal operation, future failure, and failure.

13. A monitoring system, comprising:
(a) an input for an audio signal emitted from a mechanical device;
(b) a beat detector coupled to said input;
(c) a beat analyzer coupled to said beat detector; and
(d) an status output coupled to said beat analyzer.

14. A method of audio playout, comprising the steps of:
(a) providing an audio playout device which includes a beat matcher;
(b) providing beat information corresponding to a mechanical device plus worker speed metric/desired pace information for a worker associated with said mechanical device;
(c) computing a target beat rate from said beat information plus said worker speed metric/desired pace information; and
(d) playing out an audio input for said worker wherein said playing out includes beat matching said audio input to said target beat rate.

15. An audio playout system, comprising:
(a) a first input for beat information corresponding to a mechanical device;
(b) a second input for worker speed metric/desired pace information for a worker associated with said mechanical device;
(c) a playout device coupled to said first and second inputs, wherein said playout device includes a beat matcher for playing out an audio input for said worker and at a target beat rate where said target beat rate is computed from said beat information plus said worker speed metric/desired pace information.
